(19) United States
(12) Patent Application Publication
(10) Pub. No.: US 2016/0209718 A1
(43) Pub. Date: Jul. 21, 2016

(54) LIQUID CRYSTAL DISPLAY

(71) Applicant: Samsung Display Co., Ltd., Yongin-si (KR)

(72) Inventors: Jeong Ho LEE, Seoul (KR); Hyang Yul KIM, Hwaseong-si (KR); Jun Ho SONG, Seongnam-si (KR); Jean Ho SONG, Yongin-si (KR); Su Jin LEE, Siheung-si (KR); Ji Eun LEE, Seoul (KR)

(21) Appl. No.: 14/856,088

(22) Filed: Sep. 16, 2015

(30) Foreign Application Priority Data
Jan. 20, 2015 (KR) 10-2015-0009414

(51) Int. Cl. G02F 1/1362; G02F 1/1343; G02F 1/1368

(52) U.S. Cl. CPC G02F 1/136209; G02F 1/1368; G02F 1/136286; G02F 1/136227; G02F 1/134309; G02F 2001/136222

(57) ABSTRACT

A liquid crystal display includes: a first substrate; a gate conductor disposed on the first substrate; a gate insulating layer disposed on the gate conductor; a semiconductor layer disposed on the gate insulating layer; data line and drain electrodes disposed on the semiconductor layer, the data line including a source electrode; and a first passivation layer disposed on the data line and the drain electrode, the first passivation layer including a first contact hole. The first contact hole has a substantially circular planar shape, and wherein a first region of the drain electrode corresponding to the first contact hole has a substantially circular planar shape.

### CROSS-REFERENCE TO RELATED APPLICATION

This application claims priority from and the benefit of Korean Patent Application No. 10-2015-0009414, filed on Jan. 20, 2015, which is hereby incorporated by reference for all purposes as if fully set forth herein.

### BACKGROUND

1. Field

An exemplary embodiment relates to a liquid crystal display.

2. Discussion of the Background

A liquid crystal display adjusts the amount of passing light by applying a voltage to an electrode and generating an electrical field to rearrange liquid crystal molecules of a liquid crystal layer.

To increase a transmittance of the liquid crystal display and increase a viewing angle, a liquid crystal display may include a pixel electrode and a common electrode disposed on one substrate.

A light blocking member may be reduced to increase resolution and transmittance. A contact surface (e.g., a contact hole and an opening) for connection of a pixel electrode and a drain electrode may largely affect panel characteristic (e.g., crosstalk, afterimage, and light leakage).

Research has been conducted to reduce a light blocking member for high resolution and high transmittance, but the technology has restrictions in terms of processing capability and design margin. Accordingly, in order to improve processing capability and design margin, a new design concept for a contact region is required.

The above information disclosed in this Background section is only for enhancement of understanding of the background of the inventive concept, and, therefore, it may contain information that does not form the prior art that is already known in this country to a person of ordinary skill in the art.

### SUMMARY

The exemplary embodiments provide a liquid crystal display having improved design margin and processing capability while having improved resolution and transmittance.

Additional aspects will be set forth in the detailed description which follows, and, in part, will be apparent from the disclosure, or may be learned by practice of the inventive concept.

An exemplary embodiment discloses a liquid crystal display including: a first substrate; a gate conductor disposed on the first substrate; a gate insulating layer disposed on the gate conductor; a semiconductor layer disposed on the gate insulating layer; data line and drain electrodes disposed on the semiconductor layer, the data line including a source electrode; and a first passivation layer disposed on the data line and the drain electrode, the first passivation layer including a first contact hole, wherein the first contact hole has a substantially circular planar shape, and wherein a first region of the drain electrode corresponding to the first contact hole has a substantially circular planar shape.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a plan view of a layout of a liquid crystal display according to an exemplary embodiment.

FIG. 2 is a cross-sectional view of the liquid crystal display of FIG. 1 taken along a sectional line II-II.

FIG. 3 is a cross-sectional view of the liquid crystal display of FIG. 1 taken along a sectional line III-III.

### DETAILED DESCRIPTION OF THE EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

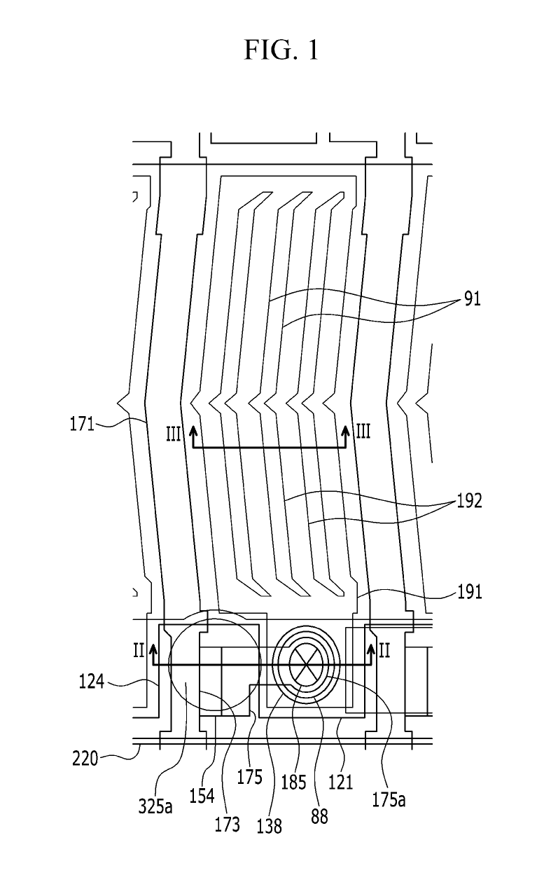

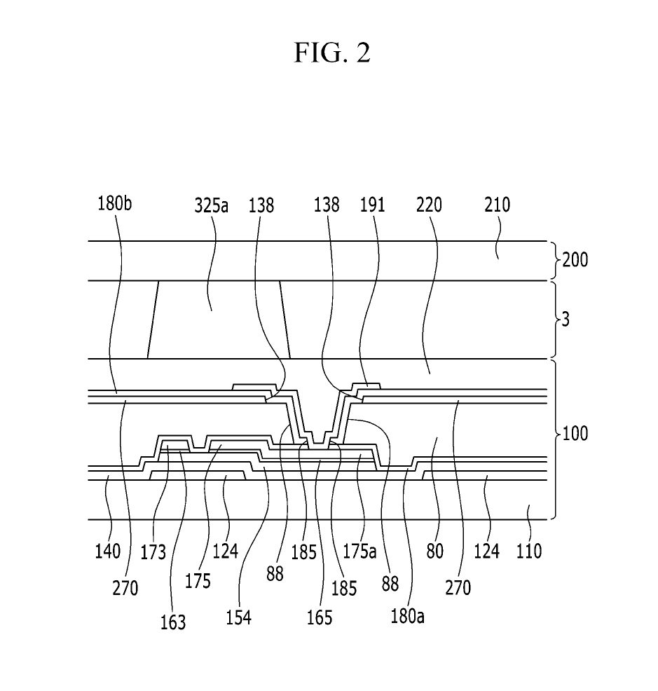

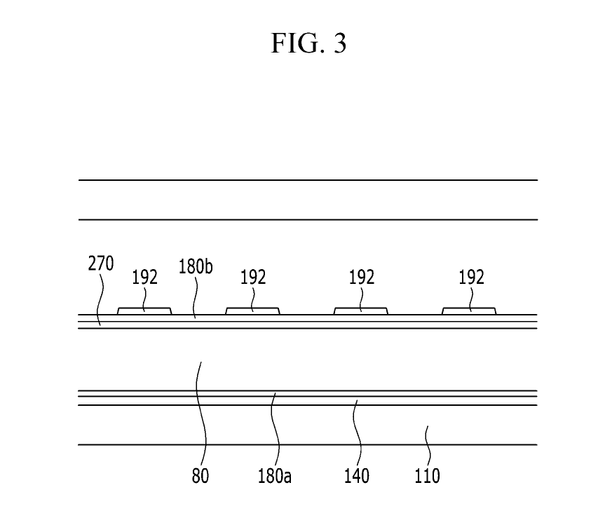

With reference to FIGS. 1, 2, and 3, a liquid crystal display according to an exemplary embodiment will be described. FIG. 1 is a plan view of a layout of a liquid crystal display according to an exemplary embodiment, FIG. 2 is a cross-sectional view of the liquid crystal display of FIG. 1 taken along a sectional line II-II, and FIG. 3 is a cross-sectional view of the liquid crystal display of FIG. 1 taken along a sectional line III-III.

Referring to FIGS. 1, 2, and 3, the liquid crystal display according to exemplary embodiments includes a lower display panel 100 and an upper display panel 200 disposed facing each other, and a liquid crystal layer 3 interposed between the two display panels 100 and 200.

First, the lower display panel 100 will be described below.

A gate conductor including a gate line 121 is disposed on a first substrate 110 formed of transparent glass and/or plastic.

The gate line 121 includes a wide end portion (not shown) for connection with a gate electrode 124 and other layers and/or an external driving circuit. The gate line 121 may be formed of aluminum based metal such as aluminum (Al) and/or aluminum alloy, silver based metal including at least one of silver (Ag) and/or Ag alloy, copper based metal such as copper (Cu) and/or copper alloy, molybdenum based metal such as molybdenum (Mo) and/or molybdenum alloy, chromium (Cr), tantalum (Ta), and titanium (Ti). The gate line 121 may have a multilayer structure including at least two conductive layers with different physical properties.

A gate insulating layer 140 formed of silicon nitride (SiNₓ) and/or silicon oxide (SiOₓ) is disposed on a gate line 121. The gate insulating layer 140 may have a multilayer structure including at least two insulating layers with different physical properties.

A semiconductor 154 formed of amorphous silicon and/or polysilicon is disposed on the gate insulating layer 140. The semiconductor 154 may include an oxide semiconductor.

Ohmic contacts 163 and 165 are disposed on the semiconductor 154. The ohmic contacts 163 and 165 may be formed of silicide and/or a material including n+ hydrogenated amorphous silicon doped with high concentration of n-type impurity such as phosphorus. The ohmic contacts 163 and 165 may be disposed as a pair on the semiconductor 154. When the semiconductor 154 is an oxide semiconductor, the ohmic contacts 163 and 165 may be omitted.

A data line 171 including a source electrode 173 and a data conductor including a drain electrode 175 are disposed on the ohmic contacts 163 and 165 and the gate insulating layer 140.

The data line 171 includes a wide end portion (not shown) for connection with other layers and/or an external driving circuit. The data line 171 transmits a data signal and extends substantially in a vertical direction to cross the gate line 121.

The data line 171 may include a first bent portion having a bent shape for improving the transmittance of the liquid crystal display and portions of the bent portion may meet at a center region of a pixel area to form a V shape. The data line 171 may further include a second bent portion bent at a predetermined angle with respect to the first bent portion at the middle region of the pixel area.

The source electrode 173 is a portion of the data line 171, and is disposed collinear with the data line 171. The drain electrode 175 is formed to extend in parallel with the source electrode 173. Accordingly, the drain electrode 175 extends in parallel with a portion of the data line 171.

The gate electrode 124, the source electrode 173, the drain electrode 175, and the semiconductor 154 forma thin film transistor (TFT), and a channel of the thin film transistor is formed in the semiconductor 154 between the source electrode 173 and the drain electrode 175.

The liquid crystal display according to the exemplary embodiments may include the source electrode 173 disposed collinear with the data line 171 and the drain electrode 175 extending in parallel to the data line 171, and the width of the thin film transistor may be increased thereby increasing an aperture ratio of the liquid crystal display, without widening an area occupied by a data conductor.

The data line 171 and the drain electrode 175 may be formed of refractory metal including at least one of molybdenum, chromium, tantalum, and titanium and/or an alloy thereof, and may have a multilayer structure including a refractory metal layer (not shown) and a low-resistance conductive layer (not shown). Examples of the multilayer structure may include at least one of dual layer of a chromium or molybdenum (alloy) lower layer and an aluminum (alloy) upper layer, and a triple layer of a molybdenum (alloy) lower layer, an aluminum (alloy) middle layer, and a molybdenum (alloy) upper layer. Referring to FIG. 1, a partial region 175a of the drain electrode 175 may have a planar shape of a circle or a similar shape thereto (e.g., a substantially circular planar shape such as an oval or a polygon close to a circle).

A first passivation layer 180a is disposed on data conductors 171, 173, and 175, the gate insulating layer 140, and an exposed portion of the semiconductor 154. The first passivation layer 180a may be formed of an organic insulating material and/or an inorganic insulating material.

A color filter 80 is disposed on the first passivation layer 180a. The color filter 80 may be formed of an organic insulator. The color filter 80 may have an opening 88 disposed corresponding to a surrounding portion of the drain electrode 175. As illustrated in FIG. 1, the opening 88 may have a planar shape of a circle or a similar shape thereto (e.g., a substantially circular planar shape such as an oval or a polygon close to a circle). An area of the opening 88 may be equal to or greater than an area of the partial region 175a of the drain electrode 175. The opening 88 may be disposed on the partial region 175a of the drain electrode 175. The partial region 175a of the drain electrode 175 may be disposed on a center portion of the opening 88. Referring to FIG. 2, an organic insulator (not shown) instead of the color filter 80 may be disposed in a region in which the color filter 80 is formed, and referring to FIG. 2, the color filter 80 may be formed in a different region other than the region in which the color filter 80 is formed without the opening 88.

The color filter 80 may display one of the primary colors. Examples of the primary colors may include three primary colors of red, green, and blue, or yellow, cyan, and magenta. The color filter may further include a color filter for displaying a mixture of the primary color or white as well as the primary color.

An overcoat (not shown) may be disposed on the color filter 80. The overcoat may include an inorganic insulating material or an organic insulating material.

A common electrode 270 is disposed on the color filter 80. The common electrode 270 is a first field generating electrode. The common electrode 270 may have a planar shape, may be disposed on an entire surface of the first substrate 110, and may include an opening 138 disposed corresponding to a surrounding portion of the drain electrode 175. That is, the common electrode 270 may have a plate shape. Referring to FIG. 1, the opening 138 may have a planar shape of a circle or a similar shape thereto (e.g., a substantially circular planar shape such as an oval or a polygon close to a circle). An area of the opening 138 may be equal to or greater than an area of the partial region 175a of the drain electrode 175. An area of the opening 138 may be equal to or greater than an area of the opening 88. The opening 138 may be disposed on the partial region 175a of the drain electrode 175. The partial region 175a of the drain electrode 175 may be disposed on the center portion of the opening 138.

Common electrodes 270 disposed on adjacent pixels are connected to each other and receive a common voltage from outside a display area.

A second passivation layer 180b is disposed on the common electrodes 270. The second passivation layer 180b may be formed of an organic insulating material and/or an inorganic insulating material.

A pixel electrode 191 is formed on the second passivation layer 180b and the color filter 80. The pixel electrode 191 includes a curved edge that is positioned in almost parallel to the first and second bent portions of the data line 171. The pixel electrode 191 includes a plurality of first cutouts 91 and includes a plurality of first branch electrodes 192 defined by the plurality of first cutouts 91.

A first contact hole 185 is formed in the first passivation layer 180a and the second passivation layer 180b, and the drain electrode 175 is exposed trough the first contact hole 185. The pixel electrode 191 is physically and electrically connected to the drain electrode 175 through the first contact hole 185 and receives a voltage from the drain electrode 175. Referring to FIG. 1, the first contact hole 185 may have a planar shape of a circle or a shape similar thereto (e.g., a substantially circular planar shape such as an oval or a polygon close to a circle). An area of the first contact hole 185 may be equal to or smaller than the area of the partial region 175a of the drain electrode 175. The area of the first contact hole 185 may be equal to or smaller than an area of the opening 88. An area of the first contact hole 185 may be equal to or smaller than an area of the opening 138. The first contact hole 185 may be disposed on the partial region 175a of the drain electrode 175. The first contact hole 185 may be disposed on the center portion of the partial region 175a of the drain electrode 175. Referring to FIG. 1, a center of the first contact hole 185 may be different from a center of the partial region 175a of the drain electrode 175. For example, the center of the first contact hole 185 may be disposed below the center of the partial region 175a of the drain electrode 175.

A light blocking member 220 is disposed on the pixel electrode 191 and the second passivation layer 180b. The light blocking member 220 may also be referred to as a black matrix. A spacer 325a is disposed on the light blocking member 220. The spacer 325a may be formed of a transparent insulating layer.

A first alignment layer (not shown) may be disposed on the lower display panel 100. The first alignment layer may be a horizontal alignment layer, a predetermined direction, and a light alignment layer.

Hereinafter, the upper display panel 200 will be described.

The upper display panel 200 includes a second substrate 210. A second alignment layer (not shown) may be disposed on the second substrate 210 formed of transparent glass or plastic. The second alignment layer may be a horizontal alignment layer, may be aligned in a predetermined direction, and may be a light alignment layer.

The liquid crystal layer 3 includes a liquid crystal molecules having positive dielectric anisotropy. A major axis of liquid crystal molecules of the liquid crystal layer 3 may be disposed in parallel with the display panels 100 and 200.

The spacer 325a may maintain a distance between the lower display panel 100 and the upper display panel 200. The spacer 325a contacts a surface of the upper display panel 200.

The pixel electrode 191 receives a data voltage from the drain electrode 175, and the common electrode 270 receives a common voltage from an external common voltage source.

The pixel electrode 191 and the common electrode 270 are field generating electrodes configured to generate an electric field, and the liquid crystal molecules of the liquid crystal layer 3 disposed between the two field generating electrodes 191 and 270 are rotated in parallel to a direction of the electric field. Polarization of light passing through the liquid crystal layer may be changed according to the alignment direction of the liquid crystal molecules.

As such, the two field generating electrodes 191 and 270 may be formed on one display panel 100, thereby enhancing transmittance of the liquid crystal display and achieving a wide viewing angle.

The liquid crystal display according to the illustrated exemplary embodiment may include the first contact hole 185, the opening 88 of the color filter 80, the opening 138 of the common electrode 270, and the partial region 175a of the drain electrode 175 that have a circle or a similar shape thereto (e.g., an oval and a polygon close to a circle). Accordingly, a distance between the gate line 121 and the opening 88 of the color filter 80 may be increased, thereby reducing an influence of a gate field and improving a light leakage margin. According to the exemplary embodiments, the drain electrode 175 and the pixel electrode 191 contact each other along a circular opening of the first contact hole 185, and therefore, a length of a contact surface (contact portion) at which the drain electrode 175 and the pixel electrode 191 contact each other may be increased and a contact between the drain electrode 175 and the pixel electrode 191 may be further stabilized. According to the exemplary embodiments, an area of the opening 88 of the color filter 80 and an area of the opening 138 of the common electrode 270 may be reduced, thereby improving the light leakage margin.

The liquid crystal display according to the exemplary embodiments may include the common electrode 270 having a planar shape of plate type and the pixel electrode 191 including a plurality of branch electrodes. The liquid crystal display according to exemplary embodiments may also include the pixel electrode 191 having a planar shape of plate type and the common electrode 270 including a plurality of branch electrodes.

The exemplary embodiments may be applicable to any cases in which two field generating electrodes are disposed on the first substrate 110 with an insulating layer interposed, including a first field generating electrode having a planar shape of plate type disposed below the insulating layer, and a second field generating electrode disposed below the insulating layer having a plurality of branch electrodes disposed above the insulating layer.

According the exemplary embodiments, each of the first contact hole 185, the opening 88 of the color filter 80, the opening 138 of the common electrode 270, and the partial region 175a of the drain electrode 175 are illustrated as having a circular shape (or a shape similar to a circle). However, the illustrated exemplary embodiments are merely exemplary, and the exemplary embodiments are not limited thereto. At least one of the first contact hole 185, the opening 88 of the color filter 80, the opening 138 of the common electrode 270, and the partial region 175a of the drain electrode 175 may have a circular shape (or a shape similar to a circle) and the remaining may be formed with other shapes (e.g., a quadrangle shape). For example, the first contact hole 185, the opening 88 of the color filter 80, and the opening 138 of the common electrode 270 may be have a circular shape (or a shape similar to a circle) and the partial region 175a of the drain electrode 175 may have a quadrangle shape (or a shape similar to a quadrangle) that is not a circle shape.

The positions, shapes, and areas of the first contact hole 185, the opening 88 of the color filter 80, the opening 138 of the common electrode 270, and the partial region 175a of the drain electrode 175 are not limited to the above illustrated exemplary embodiments, and the pixel electrode 191 and the drain electrode 175 may be changed in various ways within a range in which the pixel electrode 191 and the drain electrode 175 are electrically and physically connected.

According to the exemplary embodiments, design margin and processing capability may be improved while having high resolution and high transmittance.

According to the exemplary embodiments, a drain electrode has a circular planar shape and a contact hole for connection between the drain electrode and a pixel electrode has a circular planar shape to increase a length of a contact surface between the drain electrode and the pixel electrode, thereby improving the contact stability between the drain electrode and the pixel electrode.

According to the exemplary embodiments, even if overlay is distorted, the contact between the drain electrode and the pixel electrode may have an improved stability.

According to the exemplary embodiments, a distance between an opening of a color filter and a gate line may be increased to reduce influence of a gate field and improve panel characteristic (e.g., crosstalk, afterimage, and light leakage margin).

According to the exemplary embodiments, an area of an opening of a color filter and an area of an opening of a common electrode may be reduced to improve light leakage margin.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A liquid crystal display comprising:
a first substrate;
a gate conductor disposed on the first substrate;
a gate insulating layer disposed on the gate conductor;
a semiconductor layer disposed on the gate insulating layer;
a data line and a drain electrode disposed on the semiconductor layer, the data line comprising a source electrode; and
a first passivation layer disposed on the data line and the drain electrode, the first passivation layer comprising a first contact hole,
wherein the first contact hole has a substantially circular planar shape, and
wherein a first region of the drain electrode corresponding to the first contact hole has a substantially circular planar shape.

2. The liquid crystal display of claim 1, wherein an area of the first region is equal to or greater than an area of the first contact hole.

3. The liquid crystal display of claim 1, further comprising:
a color filter disposed on the first passivation layer, the color filter comprising a first opening corresponding to the first contact hole,
wherein the first opening has a substantially circular planar shape.

4. The liquid crystal display of claim 3, wherein an area of the first opening is greater than an area of the first contact hole.

5. The liquid crystal display of claim 3, further comprising:
a first electrode disposed on the color filter, the first electrode comprising a second opening corresponding to the first contact hole,
wherein the second opening has a substantially circular planar shape.

6. The liquid crystal display of claim 5, wherein an area of the second opening is greater than an area of the first contact hole.

7. The liquid crystal display of claim 5, wherein an area of the second opening is greater than an area of the first opening.

8. The liquid crystal display of claim 5, further comprising a second passivation layer disposed on the first electrode,
wherein the first contact hole is disposed through the second passivation layer.

9. The liquid crystal display of claim 8, further comprising:
a second electrode disposed on the second passivation layer,
wherein the second electrode and the drain electrode are connected through the first contact hole.

10. The liquid crystal display of claim 9, further comprising:
a light blocking member disposed on the pixel electrode;
a spacer disposed on the light blocking member; and
a second substrate disposed facing the first substrate.
